(19) United States
(12) Patent Application Publication
(10) Pub. No.: US 2014/0202575 A1
(43) Pub. Date: Jul. 24, 2014

(54) METHOD OF RUNNING A CONDUIT IN AN INCINERATION PLANT AND DEVICE WITH SUCH A CONDUIT

(71) Applicant: Martin GmbH fuer Umwelt- und Energietechnik, Muenchen (DE)

(72) Inventors: Toralf WEBER, Emmering (DE); Johannes MARTIN, Muenchen (DE)

(73) Assignee: Martin GmbH fuer Umwelt- und Energietechnik, Muenchen (DE)

(21) Appl. No.: 14/159,646

(22) Filed: Jan. 21, 2014

(30) Foreign Application Priority Data
Jan. 23, 2013 (DE) 10 2013 001 092.6

(51) Int. Cl. F16L 9/14

(52) U.S. Cl. CPC F16L 9/14
USPC 138/146; 137/15.01

(57) ABSTRACT

The invention relates to a method of running a conduit in an incineration plant as well as a device with a conduit, in which the conduit is surrounded by a ceramic component onto which flue gas flows from at least two opposite directions, wherein between the conduit and ceramic component a protective fluid space with a protective fluid inlet and/or heat exchanger pipes is provided.

The invention relates to method of running a conduit in an incineration plant and a device with a conduit. More particularly, the invention relates to method of running a conduit in an incineration plant in which the conduit is surrounded by a ceramic component onto which flue gas flows from at least two opposite sides, as well as a device with such a conduit.

In incineration plants temperature of several hundred degrees Celsius occur, and particularly in the case of boiler plants it is useful to keep the temperatures in the heat generation area as high as possible in order to assure a high degree of efficiency of the boiler plant. To optimise the plants it makes sense not only to provide heat exchangers, but also measuring instruments, gas removal or fluid inlet devices not only on the plant walls, but also in the central area of the heat generator, such as in the incineration chamber and the flue gas extractors. As a consequence of the extremely high temperatures, and in particular when burning solid fuels, due to the deposits caused by the dust emitted from the burning bed, such devices onto which flue gas flows from at least two opposite sides would only have a limited service life. Even if the conduits are surrounded by a ceramic component, this is no adequate protection for many applications, so that particularly the supply of media to the incineration chamber or the flue gas stacks is limited to nozzles on the walls of the incineration plant.

The aim of the invention is to further develop a method of this type and a device of this type.

According to the method, this is achieved in that a protective fluid is supplied between the conduit and the ceramic component.

As a standing fluid, the fluid between the conduit and the ceramic component can restrict heat exchange. However, as a flowing fluid the protective fluid can cool if further fluid is continuously fed in.

The conduit to be protected can be a pipe or a hose. It can also, however, be an electrical lead, carrying a measuring device for example.

The protective fluid can be a liquid, a vapour or a gas. Preferably air is used as the protective fluid. Especially if the ceramic component is not completely sealed or parts in the ceramic component are to be cooled, it is advantageous if air is continuously supplied, so that at least a small excess pressure in the ceramic component compared with the atmosphere surrounding the ceramic component is guaranteed.

It is particularly advantageous if the protective fluid is supplied at the hottest point of the ceramic component. In this way a cooling function can also be achieved. It is also advantageous if the protective fluid is supplied in a lower section of the ceramic component as it then heats up there and rises in the ceramic component. However, the protective fluid can also be supplied at one or more points of the ceramic component or at one or more points over the entire height of the ceramic component.

In order to be able to give off a fluid into the atmosphere surrounding the ceramic component, to take gases from there or to measure temperatures, it is proposed that the conduit is taken through the protective fluid and the ceramic component. For this a drilled hole or another opening in the ceramic component can act as part of the conduit.

A particularly preferred variant of the method envisages that a medium for fluid gas denitrification is conveyed in the conduit. This allows, for example, an ammoniac or urea component to be added at any point in the incineration chamber or the fluid gas stacks, and more particularly to the flue gas at different heights. This is preferably achieved through several conduits and nozzles at different heights in the ceramic component.

The conduits provided for supplying a fluid can also be used for removing a gas sample, or further conduits are provided on the ceramic component for taking gas samples.

The temperature in a protective fluid space can be set by the supplied protective fluid or by a regulated temperature of heat exchanger pipes arranged in the protective fluid space.

In terms of the device, the aim on which the invention is based is achieved with a device of the type in question, in which a protective fluid space is provided between the conduit and the ceramic component.

This protective fluid space preferably has a protective fluid inlet.

It is advantageous if the conduit runs through the protective fluid space and through the ceramic component, whereby the conduit can run either in the ceramic component or a drilled hole or another opening in the ceramic component can act as part of the conduit.

In order to convey the protective fluid to a particular point in the ceramic component, it is proposed that a protective fluid conduit is arranged in the ceramic component which extends through the ceramic component. This protective fluid conduit preferably runs perpendicularly through the ceramic component up to a lower section of the ceramic component in order to supply the protective fluid there and allow it to rise between the protective fluid conduit and the ceramic component.

In order to feed a gas or a liquid into the incineration chamber or the flue gas stacks it is proposed that the ceramic component has one and preferably several nozzles. Accordingly for temperature measurement it is proposed that the ceramic component has one and preferably several temperature measuring devices.

If the protective fluid is a gas, such as in particular, air, it is advantageous if the protective air inlet has a fan.

A preferred variant of embodiment envisages that the protective fluid space has at least one heat exchanger pipe. Preferably this heat exchanger pipe is also surrounded by a protective fluid space, so that the heat exchanger pipe, like the other conduits, is protected by the protective fluid. The heat exchanger pipe can also be used to set a desired temperature in the ceramic component.

Particularly if measuring devices, such as temperature measuring devices, gas analysers or removal device are provided on or in the ceramic component, it is advantageous if the protective fluid space has cables for these measuring devices.

One example of embodiment of a device with conduits in a ceramic component is shown in the drawing and will be described in more detail below.

Shown in

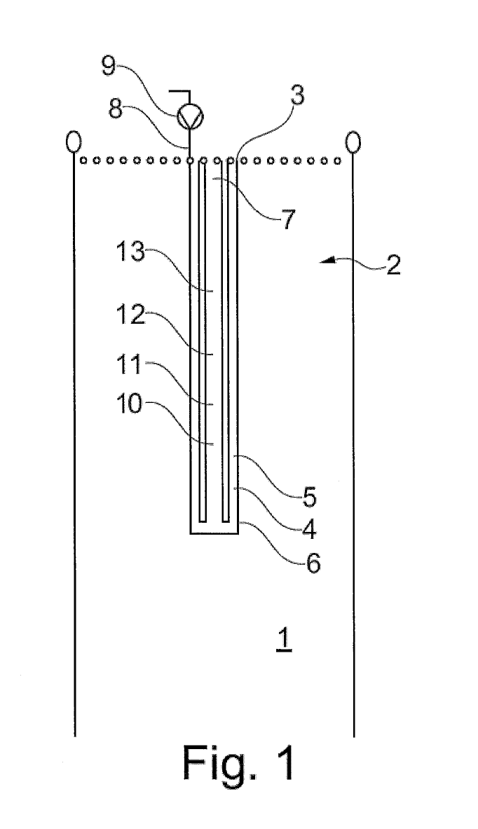

FIG. 1 is a schematic section through an area of an incineration plant with a ceramic component,

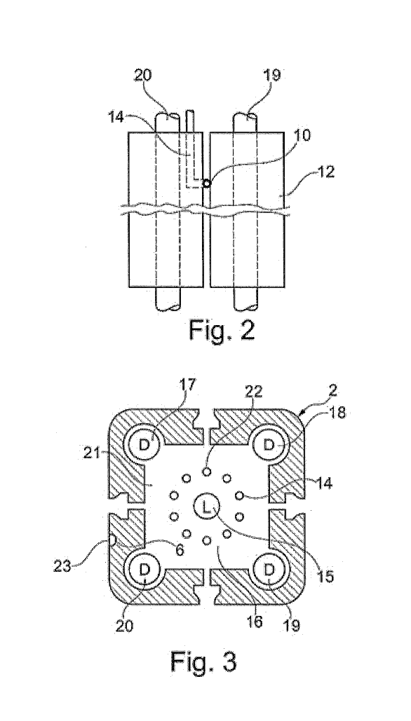

FIG. 2 is an enlarged view of a detail of the ceramic component, and

FIG. 3 a section through the ceramic component shown in FIG. 2.

In the incineration chamber 1 shown schematically in FIG. 1, a ceramic component 2 is arranged in such a way that it is suspended on the ceiling 3 of the incineration chamber in the flue gas stack. This ceramic component 2 consists of several ceramic elements 4, 5 which are arranged over each other and form a hollow rod. The lowermost ceramic element 6 forms an essentially gas-tight closure and the uppermost ceramic element 7 has a protective fluid inlet 8 with a fan 9. Several ceramic elements 5 have nozzles 10 to 13 which are each connected to a conduit 14.

The ceramic component freely suspended in the incineration chamber 1 thus has flue gas flowing onto it from all sides, with the exception of the side on which the ceramic component 2 is suspended. The ceramic elements 4, 5, 6, 7 can be loosely stacked on top of each other or joined with mortar.

Arranged within these ceramic elements is a protective fluid conduit 15, which is supplied with air via the protective fluid inlet and the fan 9. The protective fluid conduit 15 extends through all the ceramic elements 7, 4, 5 to the lowermost ceramic element 6, where the protective fluid emerges from the protective fluid conduits 15 and rises in the protective fluid space 16.

In addition, arranged in the protective fluid 16 within the ceramic component 2 are heat exchanger pipes 17 to 20 around which a protective fluid 21 also flows. Cables run along the ceramic component 2 in the protective fluid space 16 in order to connect measuring device, such as, for example, a temperature measuring device 23, with an evaluation device (not shown).

1. Method of running a conduit (14) in an incineration plant, in which the conduit (14) is surrounded by a ceramic component (2), onto which fluid gas flows from at least two opposite sides, wherein a protective fluid (21) is supplied between the conduit (14) and the ceramic component (2).

2. Method according to claim 1, wherein the conduit (14) is a pipe or hose.

3. Method according to claim 1, wherein the conduit (14) is an electrical lead.

4. Method according to claim 1, wherein the protective fluid (21) is a gas, preferably air.

5. Method according to claim 1, wherein the protective fluid (21) is supplied at the hottest point or in a lower section of the ceramic component (2).

6. Method according to claim 1, wherein the protective fluid (21) is supplied at one or more points of the ceramic component (2).

7. Method according to claim 1, wherein the conduit (14) runs through the protective fluid (21) and the ceramic component (2).

8. Method according to claim 1, wherein a medium for flue gas denitrification is conveyed in the conduit (14).

9. Method according to claim 1, wherein a gas sample is taken via the conduit (14).

10. Method according to claim 1, wherein the temperature in a protective fluid space (16) is set through the temperature of the supplied protective fluid or a regulated temperature of heat exchanger pipes (17-20) arranged in the protective fluid space (16).

11. Device with a conduit (14) which is surrounded by a ceramic component (2) onto which flue gas flows from at least two opposite directions wherein between the conduit (14) and the ceramic component (2) a protective fluid space (16) is provided.

12. Device according to claim 11, wherein the protective fluid space (16) has a protective fluid inlet (8).

13. Device according to claim 11, wherein the conduit (14) passes though the protective fluid space (16) and through the ceramic component (2).

14. Device according to claim 11, wherein arranged in the ceramic component (2) is a protective fluid conduit (15) which extends through the ceramic component (2).

15. Device according to claim 11, wherein the ceramic component (2) has one and preferably several nozzles (10-13).

16. Device according to claim 11, wherein the ceramic component (2) has one and preferably several temperature measuring devices (23).

17. Device according to claim 12, wherein the protective fluid inlet (8) has a fan (9).

18. Device according to claim 11, wherein the protective fluid space (16) has at least one heat exchanger pipe (17-20).

19. Device according to claim 11, wherein the protective fluid space (16) has cables (22) for measuring devices.
